(19) United States
(12) Patent Application Publication
(10) Pub. No.: US 2015/0085869 A1
(43) Pub. Date: Mar. 26, 2015

(54) REDUCED ACKNOWLEDGEMENT OF PSEUDOWIRE STATUS SIGNALLING MESSAGES

(71) Applicant: ALCATEL-LUCENT, Paris (FR)

(72) Inventors: Shafiq PIRBHAI, Ottawa (CA); Matthew BOCCI, London (GB); Suresh VG NAIR, Cupertino, CA (US)

(73) Assignee: ALCATEL-LUCENT, Paris (FR)

(21) Appl. No.: 14/035,137

(22) Filed: Sep. 24, 2013

(51) Int. Cl. H04L 12/721

(52) U.S. Cl. CPC H04L 45/68
USPC 370/409

(57) ABSTRACT

Various exemplary embodiments relate to a method of acknowledging a pseudowire (PW) status message by a PW node, the method including: receiving at the PW node a PW status message from a peer node; determining that acknowledging the PW status message will reduce the number of PW status messages sent by the peer node; and sending an acknowledgement message to the peer node acknowledging the receipt of the PW status message from the peer node.

### TECHNICAL FIELD

Various exemplary embodiments disclosed herein relate generally to communication over pseudowires.

### BACKGROUND

FIG. 1 illustrates the basic concept of a pseudowire (PW) in a communication network. In the network 100, pseudowires 105a-b are defined to run over a packet network 115, such as, IP networks, layer two tunneling protocol (L2TP) networks, MPLS networks, etc. These networks provide the packet “cloud” 115 through which connection-oriented tunnels 110 are formed to support pseudowires 105a-b. For the common MPLS case, two unidirectional, inner-tunnel, label-switched paths (LSPs) are contained within unidirectional, outer-tunnel LSPs (which act as traffic-engineering tunnels) and create a bidirectional connection between provider edge (PE) routers.

The inner LSPs form the pseudowires 105a-b by using an interworking function (IWF)—currently residing at the PE, although it can easily and rapidly migrate to the customer equipment (CE)—that encapsulates the CE data transmission format, such as frame relay, asynchronous transfer mode (ATM), or Ethernet, from the attachment circuit into a standard packetized pseudowire format. At the far end of the pseudowire 105a-b, the data is unencapsulated and handed over to the destination CE.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of acknowledging a pseudowire (PW) status message by a PW node, the method including: receiving at the PW node a PW status message from a peer node; determining that acknowledging the PW status message will reduce the number of PW status messages sent by the peer node; and sending an acknowledgement message to the peer node acknowledging the receipt of the PW status message from the peer node.

Various exemplary embodiments relate to a pseudowire (PW) node including: a network interface; a memory; and a processor in communication with the memory, the processor being configured to: receive at the PW node a PW status message from a peer node; determine that acknowledging the PW status message will reduce the number of PW status messages sent by the peer node; and send an acknowledgement message to the peer node acknowledging the receipt of the PW status message from the peer node.

Various exemplary embodiments relate to a non-transitory machine-readable storage medium encoded with instructions for execution by a pseudowire (PW) node for acknowledging a pseudowire (PW) status message, the medium including: instructions for receiving at the PW node a PW status message from a peer node; instructions for determining that acknowledging the PW status message will reduce the number of PW status messages sent by the peer node; and instructions for sending an acknowledgement message to the peer node acknowledging the receipt of the PW status message from the peer node.

### BRIEF DESCRIPTION OF THE DRAWINGS

In order to better understand various exemplary embodiments, reference is made to the accompanying drawings, wherein:

FIG. 1 illustrates the basic concept of a pseudowire (PW) in a communication network;

FIG. 2 illustrates a pseudowire status message and acknowledgment message exchange;

FIG. 3 includes a flow chart illustrating a method of determining when to send an acknowledgement message in response to a PW status message; and

FIG. 4 illustrates a hardware diagram of an exemplary PW node.

To facilitate understanding, identical reference numerals have been used in the Figures and the text to designate elements having substantially the same or similar structure or substantially the same or similar function.

Herein, various embodiments are described more fully by the Figures and the Detailed Description. Nevertheless, the inventions may be embodied in various forms and are not limited to the specific embodiments that are described in the Figures and Detailed Description.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. As used herein, the terms “context” and “context object” will be understood to be synonymous, unless otherwise indicated.

RFC6478 describes a standard mechanism for advertising the status of a pseudowire (PW) that is not controlled by a label distribution protocol (LDP) session. Such a pseudowire has labels that are manually configured by the operator and is termed a static pseudowire. This solution may involve sending a packet in-band containing a bit field representing the status of the PW along an associated control channel on the PW between a sending PE node and a receiving PE node. The PW status message may be periodically refreshed at a refresh timer interval.

RFC6478 includes an acknowledgement mechanism to acknowledge PW status messages. Accordingly, a PW node acknowledges all PW status messages received by sending an acknowledgement message. This has the drawback of doubling the number of messages dedicated to communicating PW status between the PW nodes. Also RFC6478 allows for no acknowledgement of PW status messages. While this may reduce the number of messages dedicated to communicating PW status between the PW nodes, it leads to a lack of knowledge of a peer's status. Further, acknowledging PW status messages is useful when a PW status change occurs. In this situation, the PW node with the status change may send out three PW status messages at 1 second intervals. If an acknowledgement is received from the peer network within 1 second, the PW node will stop the transmission of the subsequent PW status message messages.

The above described acknowledgement mechanism may create too many unnecessary acknowledgement messages in the PW network. Accordingly, there remains a need to acknowledge the receipt of PW status messages will reducing the number of messages dedicated to communicating PW status between the PW nodes.

Described herein are embodiments that only acknowledge PW status messages when it is likely that the number of messages in the PW network may be reduced. This may occur when three PW status messages may be sent at 1 second intervals. In such a case, if the first PW status message is acknowledged, then the transmission of the two additional messages may be prevented, thus reducing the number of messages in the PW network. Described below are various cases where this may be accomplished.

In a first case, a PW status change on a PW node, Node A, may result in Node A sending a PW status message to a peer node, Node B. The PW status message may contain new PW status bits indicating the change in PW status at Node A. Node B receives the PW status message and determines that the PW status of Node A has changed. In response, Node B may send an acknowledgement message to Node A. As a result of receiving the acknowledgement message, Node A may stop transmission of the next two PW status messages that contain the same information.

In a second case, the PW status at Node B may expire. This may occur according to RFC6478 when Node B has not received any PW status message from Node A over a time interval of 3.5 times the refresh timer interval. Node B may then acknowledge the next PW status message that Node B receives. Such a situation may occur, for example if Node A went down and then came back up. In that case, Node A would attempt to send three PW status messages at 1 second intervals. The acknowledgement message from Node B would result in Node A stopping transmission of the last two messages.

In a third case, Node B may receive a PW status message from Node A where the refresh timer in the current PW status message is different from the refresh time in a previous PW status message from Node A. This may occur because the protocol on Node A went down and then restarted. This may cause the value of the refresh timer to change, which would indicate to Node B a restart of the protocol at Node A. Node B may then acknowledge this received PW status message. In that case, Node A would attempt to send three PW status messages at 1 second intervals. The acknowledgement message from Node B would result in Node A stopping transmission of the last two messages.

In a fourth case, Node B may send an acknowledgement message the first time Node B ever receives a PW status message from Node A. In that case, Node A would attempt to send three PW status messages at 1 second intervals. The acknowledgement message from Node B would result in Node A stopping transmission of the last two messages.

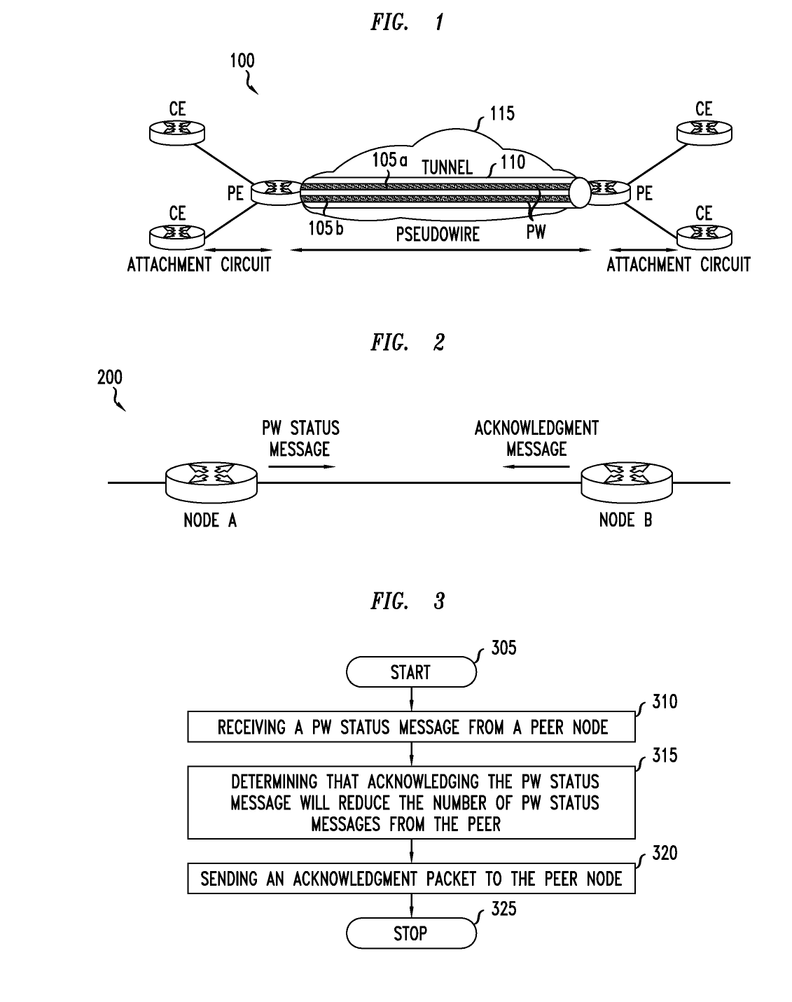

FIG. 2 illustrates a pseudowire status message and acknowledgment message exchange. A PW system 200 includes Node A and Node B. A PW may be established between Node A and Node B. Node A may send a PW status message to Node B. Node B may acknowledge the PW status message from Node A. Node B may only acknowledge PW status messages from Node A when Node B determines that such an acknowledgement may reduce the number of PW status messages from Node A.

FIG. 3 includes a flow chart illustrating a method of determining when to send an acknowledgement message in response to a PW status message. The method 300 starts at 305. Next, the PW node may receive a PW status message from a peer node 310. The PW node then determines whether acknowledging the PW status message will reduce the number of PW status messages sent from the peer node 315. Four examples of where this is the case are described above. Next, the PW node may send an acknowledgement packet to the peer node when it is determined that the acknowledgment message will reduce the number of PW status messages sent from the peer node 320. The method then ends at 325. The method 300 may be implemented on any PW mode. The method may be implemented using hardware logic or programming instructions carried out on a processor.

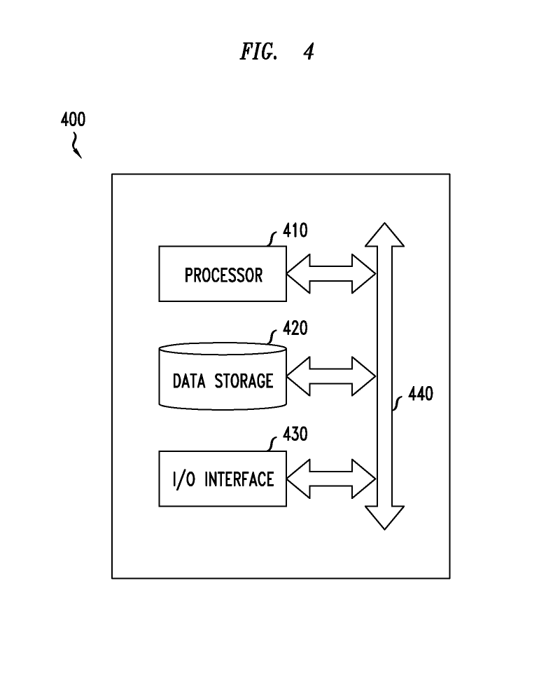

FIG. 4 illustrates a hardware diagram of an exemplary PW node. The exemplary PW node 400 may correspond to the exemplary Node A or Node B of FIG. 2. The PW node 400 may include a processor 410, a data storage 420, an input/output (I/O) interface 430, and system bus 440.

In some embodiments, the processor 410 may include resources such as processors/CPU cores, the I/O interface 430 may include any suitable network interfaces, or the data storage 420 may include memory or storage devices. Moreover the PW node 400 may be any suitable physical hardware configuration such as: one or more servers or blades consisting of components such as processor, memory, network interfaces or storage devices.

The data storage 420 and the processor 410 may reside in two different physical machines. In some embodiments, the PW node 400 may be a general purpose computer programmed to perform the methods described herein. When processor-executable programs are implemented on a processor 410, for example, programs that perform the methods described herein, the program code segments combine with the processor 410 to provide a unique device that operates analogously to specific logic circuits.

In various methods described and/or recited in this application, various steps of methods may be performed in a sequential manner, a parallel manner, or in a partially parallel manner.

It should be appreciated by those skilled in the art that any block diagrams herein represent conceptual views of illustrative circuitry embodying the principles of the invention.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method of acknowledging a pseudowire (PW) status message by a PW node, the method comprising:
receiving at the PW node a PW status message from a peer node;
determining that acknowledging the PW status message will reduce the number of PW status messages sent by the peer node; and
sending an acknowledgement message to the peer node acknowledging the receipt of the PW status message from the peer node.

2. The method of claim 1, wherein determining that acknowledging the PW status message will reduce the number of PW status messages sent by the peer node includes determining that the status of the peer node has changed.

3. The method of claim Error! Reference source not found., wherein determining that the status of the peer node has changed includes determining PW status bits in the PW status message have changed.

4. The method of claim 1, wherein determining that acknowledging the PW status message will reduce the number of PW status messages sent by the peer node includes determining that the PW status at the PW node has expired.

5. The method of claim 4, wherein determining that the PW status at the PW node has expired includes determining that the peer node has not received a PW status message from the peer node for a specified interval of time.

6. The method of claim 10, wherein the specified interval of time is defined as a scale factor times a refresh timer interval, wherein the scale factor is predetermined.

7. The method of claim 1, wherein determining that acknowledging the PW status message will reduce the number of PW status messages sent by the peer node includes determining that a refresh timer value in the PW status message is different from a refresh timer value in a previously received PW status message.

8. The method of claim 1, wherein determining that acknowledging the PW status message will reduce the number of PW status messages sent by the peer node includes determining that the PW status message is the first PW status message received from the peer node.

9. A pseudowire (PW) node comprising:
a network interface;
a memory; and
a processor in communication with the memory, the processor being configured to:
receive at the PW node a PW status message from a peer node;
determine that acknowledging the PW status message will reduce the number of PW status messages sent by the peer node; and
send an acknowledgement message to the peer node acknowledging the receipt of the PW status message from the peer node.

10. The PW node of claim 9, wherein determining that acknowledging the PW status message will reduce the number of PW status messages sent by the peer node includes determining that the status of the peer node has changed.

11. The PW node of claim 10, wherein determining that the status of the peer node has changed includes determining PW status bits in the PW status message have changed.

12. The PW node of claim 9, wherein determining that acknowledging the PW status message will reduce the number of PW status messages sent by the peer node includes determining that the PW status at the PW node has expired.

13. The PW node of claim 12, wherein determining that the PW status at the PW node has expired includes determining that the peer node has not received a PW status message from the peer node for a specified interval of time.

14. The PW node of claim 13 wherein the specified interval of time is defined as a scale factor times a refresh timer interval, wherein the scale factor is predetermined.

15. The PW node of claim 9, wherein determining that acknowledging the PW status message will reduce the number of PW status messages sent by the peer node includes determining that a refresh timer value in the PW status message is different from a refresh timer value in a previously received PW status message.

16. The PW node of claim 9, wherein determining that acknowledging the PW status message will reduce the number of PW status messages sent by the peer node includes determining that the PW status message is the first PW status message received from the peer node.

17. A non-transitory machine-readable storage medium encoded with instructions for execution by a pseudowire (PW) node for acknowledging a pseudowire (PW) status message, the medium comprising:
instructions for receiving at the PW node a PW status message from a peer node;
instructions for determining that acknowledging the PW status message will reduce the number of PW status messages sent by the peer node; and
instructions for sending an acknowledgement message to the peer node acknowledging the receipt of the PW status message from the peer node.

18. The non-transitory machine-readable storage medium of claim 17, wherein determining that acknowledging the PW status message will reduce the number of PW status messages sent by the peer node includes determining that the status of the peer node has changed.

19. The non-transitory machine-readable storage medium of claim 17, wherein determining that acknowledging the PW status message will reduce the number of PW status messages sent by the peer node includes determining that the PW status at the PW node has expired.

20. The non-transitory machine-readable storage medium of claim 17, wherein determining that acknowledging the PW status message will reduce the number of PW status messages sent by the peer node includes determining that a refresh timer value in the PW status message is different from a refresh timer value in a previously received PW status message.

21. The non-transitory machine-readable storage medium of claim 17, wherein determining that acknowledging the PW status message will reduce the number of PW status messages sent by the peer node includes determining that the PW status message is the first PW status message received from the peer node.
